(19) United States
(12) Patent Application Publication
(10) Pub. No.: US 2003/0091297 A1
(43) Pub. Date: May 15, 2003

(54) Fiber optic connector and method of making the same

(76) Inventors: Ngo V. Hung, Harrisburg, PA (US); Simon Cowley, Suwanee, GA (US)

Correspondence Address: Michael J. Bonella, Esq., WOODCOCK WASHBURN KURTZ, MACKIEWICZ & NORRIS LLP, One Liberty Place - 46th Floor, Philadelphia, PA, 19103, US

(21) Appl. No.: 10/005,265

(22) Filed: Nov. 12, 2001

(51) Int. Cl. G02B 6/36

(52) U.S. Cl. 385/83; 385/80; 385/78

(57) ABSTRACT

An optical fiber connector includes two matching ferrule connectors that each have a ferrule, an optical fiber array and a ferrule cap. The ferrule connectors match because they each have a cut surface that includes a cut end of the ferrule, the ferrule cap and the optical fiber array. Each ferrule connector is formed by attaching an optical fiber array to a ferrule, attaching a ferrule cap to the optical fiber array and the ferrule to form a subassembly. The subassembly of the ferrule, the optical fiber array and the ferrule cap are cut to form two matching ferrule connectors that each have a matching cut surface. This process can be done on a large scale to form a plurality of ferrule connectors and any ferrule connector's cut surface will precisely match with the cut surface of another ferrule connector. Preferably, the cutting is accomplished according to a method of this invention with high pressure water jets.

### FIELD OF THE INVENTION

The inventions disclosed herein relate to connectors for optical fibers and methods of manufacturing optical fiber connectors.

### BACKGROUND OF THE INVENTION

As is known in the art, optical fiber ribbon cables can be used for the transmission of optical signals. With the acceptance and general usage of optical fiber ribbon cables for signal transmission, it has becoming increasingly more important to develop optical connectors. Such connectors must be able to connect fiber ribbon cables and prevent a significant degradation in signal between the connected cables.

As is generally understood in the art, in order to prevent signal degradation, the fiber optic cables must be aligned within relatively close tolerances. Factors that can effect the amount of signal degradation include the gap separation between cables, lateral separation due to misalignment between cables and thermal expansion of connectors. Thus, one challenge in manufacturing optical fiber connectors is ensuring that any two connectors will match so that there is minimal misalignment, gap separation and differing degrees of thermal expansion. Any misalignment can create signal degradation. This invention relates to an improved optical fiber connector and a method of manufacturing an optical fiber connector that minimizes or prevents misalignment between connected optical fiber cables.

### SUMMARY OF THE INVENTION

According to one aspect of the inventions set forth herein, an optical fiber connector includes a ferrule and a plurality of optical fibers attached to either side of the ferrule. This optical fiber connector can be mating to a corresponding optical fiber connector that also has a ferrule and a ferrule cap disposed over the plurality of optical fibers. The pair of connectors can be made according to a method of this invention which includes cutting a ferrule subassembly with high pressure water. The ferrule subassembly may include a ferrule with a plurality of optical fibers attached to the ferrule. This subassembly can be cut by any means such as high pressure water to form the two matching ferrule connectors. Preferably, the subassembly is cut along a dicing line, which is preferably an angular line that extends transversely through the subassembly.

According to another aspect of the method of this invention, the optical fibers may be inserted into a grooves in the ferrule prior to the cutting process. There may be a plurality of grooves on the top and the bottom of the ferrule, so that an optical array can be inserted into both the top and the bottom of the ferrule. In a preferred embodiment, the grooves are substantially v-shaped. Epoxy may be used to adhere the optical fibers to the ferrule.

The method of this invention may also include attaching a ferrule cap to either side of the ferrule. Preferably, the ferrule caps can be disposed over the optical fibers which are attached to either side of the ferrule. The ferrule caps may have keys that slide within corresponding key ways of the ferrule. Each of the ferrule caps may have a window through which an adhesive, preferably epoxy, can be inserted to secure the ferrule caps to the ferrule and the optical fiber arrays.

Each of the mating connectors can have one or more alignment holes for receiving an alignment pin, which can be used to align the mating connectors. In a preferred embodiment, the alignment holes are circular and the aligning pins are correspondingly shaped.

The mating connectors may further have another pair of alignment slots. These slots are preferably shaped to have a circular portion, a v-shaped portion and a pair of vertical slots. A correspondingly shaped alignment pin can be inserted through these alignment slots to align the connectors together. The components to which the mated connectors are coupled can also have corresponding alignment slots through which the alignment pins can be inserted.

According to another aspect of the invention, the ferrule is a single-piece ferrule. The single piece ferrule has a mid-section having a plurality of grooves for receiving a plurality of optical fibers. The ferrule further has a cover extending over the mid-section, which encloses the optical fibers within the ferrule.

The ferrule can be created by cutting a ferrule subassembly that has a mid-section and a cover in half along a dicing line. Cutting the one-piece ferrule subassembly in half creates two one-piece ferrules that are perfect matches. This one-piece ferrule has several advantages because of its one-piece construction. The one-piece construction reduces the likelihood of misalignment due to manufacturing imperfections and thermal expansion.

The mid-section of the one-piece ferrule may have a second side that has grooves for receiving optical fibers. Further, the ferrule may have a second cover that extends over the second side. This second cover preferably is integral with the mid-section so that the ferrule has a one-piece construction. The one-piece ferrule may also have a first end and a second end which each have an alignment hole extending therethrough. The first and the second covers may extend from one of the ends over the mid-section.

This invention also includes the ferrule connectors formed from the processes described above. Other features of the inventions are described below.

### BRIEF DESCRIPTION OF THE DRAWINGS

FIG. 1 is a perspective view of a preferred embodiment of an optical fiber connector of this invention being connected to an optical fiber component;

FIG. 2 is a perspective view of the optical fiber connector of FIG. 1 with the alignment pins removed;

FIG. 3 is a perspective view of a preferred embodiment of a connector subassembly;

FIG. 4 is a perspective view of two mating portions of the optical fiber connector of FIG. 1;

FIG. 5 is a perspective view of a second preferred embodiment of an optical fiber connector subassembly;

FIG. 6 is a perspective view of the embodiment of FIG. 5 that shows the dicing line;

FIG. 7 is a perspective view of a third preferred embodiment of an optical fiber connector subassembly;

FIG. 8 is a second perspective view of the third preferred embodiment of FIG. 7;

FIG. 9 is an assembly perspective view of a ferrule subassembly according to a fourth preferred embodiment of this invention;

FIG. 10 is a perspective view of the ferrule subassembly of FIG. 9;

FIG. 11 is a perspective view of a third preferred embodiment of this invention;

FIG. 12 is a perspective view of a first end of the embodiment of FIG. 11; and

FIG. 13 is a perspective end view of a second end of the embodiment of FIG. 11.

### DETAILED DESCRIPTION OF PREFERRED EMBODIMENTS

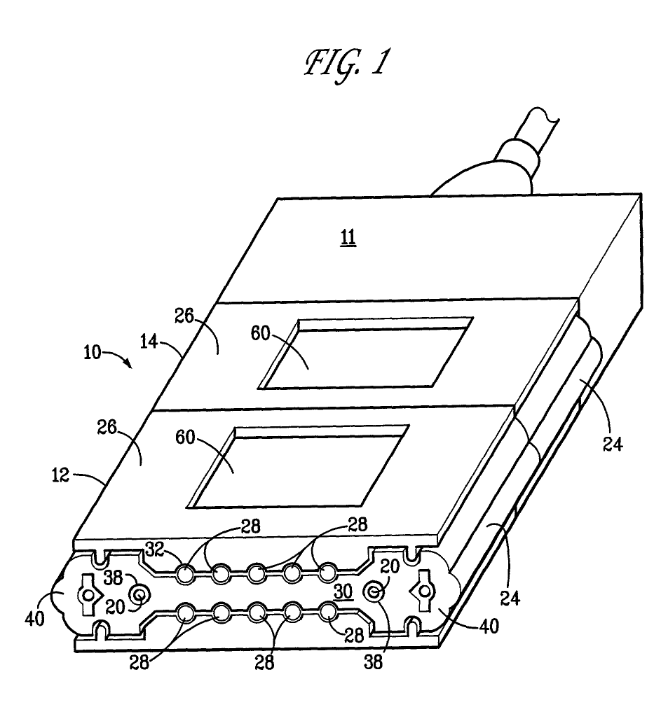

FIG. 1 is a perspective view of a preferred embodiment of an optical fiber connector 10, including its two mating connectors 12, 14, being mated with another optical fiber component 11. It will be appreciated that the optical fiber connector 10 of this invention could be mated with any of a variety of fiber optical components 11 and the particular component depicted in FIG. 1 is provided merely by way of example. Alignment pins are used to align the mating connectors 12, 14 and to align the connector 10 to the fiber optic component 11. It will further be appreciated that the optical fiber connector 10 could be mated with another fiber optic component at its other end even though another such component is not shown.

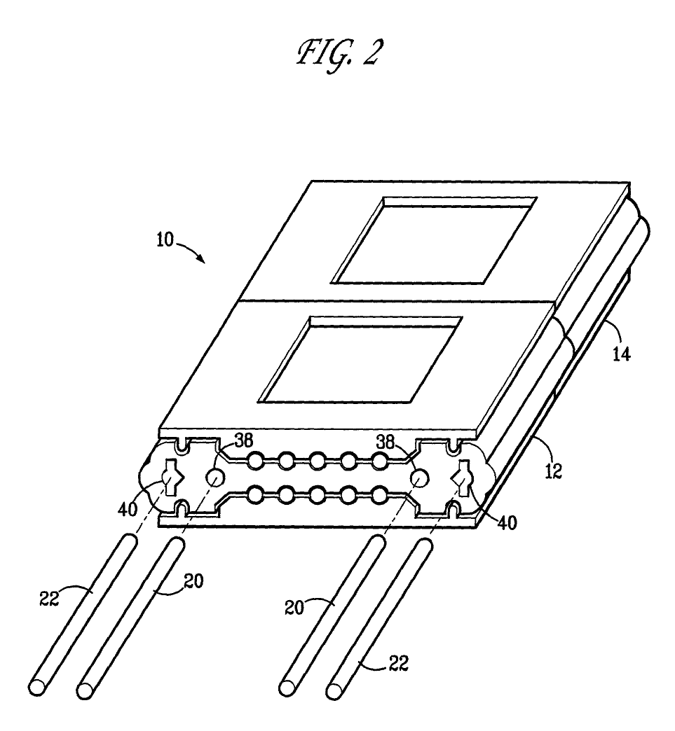

FIGS. 2-4 depict a preferred embodiment of an optical fiber connector 10 according to a preferred embodiment of this invention. The optical fiber connector 10 may include a first connector 12 and a second connector 14. As described in more detail below, the first connector 12 and the second connector 14 are manufactured in one piece and then precisely cut to form the two matching connectors 12, 14. The manufacturing of the first and the second connectors 12,14 may include as described in detail below the formation of a connector subassembly which is then cut to from a first 12 and a second connector 14. After being cut, the mating connectors 12, 14 each have a cut surface 16, 18 (shown in FIG. 4) which precisely matches the cut surface of another such connector 12, 14. These cut surfaces 16, 18 can be precisely matched to form the connector 10. Because each of the connectors 12, 14 have a cut surface that precisely matches a cut surface of another such connector 12, 14, the connectors 12, 14 can be mass produced and then any connector of the type 12 can be mated with a connector of the type 14 and the two can be mated together by mating their cut surfaces 16, 18. Since the surfaces are cut relatively precisely, they will match with another connector's cut surface. This provides for a relatively precise alignment between optical fibers, and minimizes any signal degradation due to misalignment. Moreover, because the connectors 12,14 precisely match, the production yield is increased when mass producing such connectors 12,14, which results in a cost reduction.

### FIRST PREFERRED EMBODIMENT

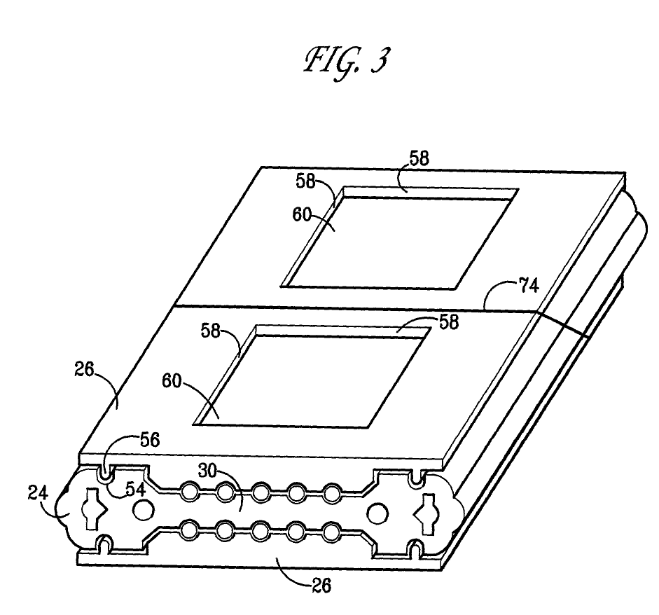

A first preferred embodiment of a pair of matching connectors 12, 14 is shown in FIGS. 1-4. FIG. 1 depicts the matching connectors 12, 14 mated with alignment pins 20, 22, and FIG. 2 depicts the matching connectors 12, 14 aligned with the alignment pins 20, 22 being inserted. FIG. 3 depicts the subassembly which includes the matching connectors 12, 14, and FIG. 4 depicts the subassembly of FIG. 3 cut to form the two matching connectors 12, 14. In the embodiment shown, the first and the second connectors 12, 14 each have a ferrule 24, a ferrule cap 26 and an array of optical fibers 28. The construction of the connectors 12, 14 as well as the method of making them can best be understood with reference to FIGS. 1-4.

FIG. 3 depicts a ferrule 24 before being assembled to form the subassembly of FIG. 4. The subassembly of FIG. 4 is cut as described in more detail below to form the two matching connectors 12, 14, as shown in FIG. 3.

As shown in FIGS. 1-4, the ferrules 24 generally have a one-piece I-beam configuration. Preferably, the ferrules are silicon, but any suitable material may be employed. The ferrule 24 preferably includes a middle section 30, which has a plurality of grooves 32. As is also depicted in FIGS. 1-4, the grooves 32 may extend longitudinally across the middle section 30 on both sides of the middle section 30. The grooves 32 are for receiving an optical fiber array 28, as shown in FIG. 1.

Disposed within the ferrule 24 is preferably an alignment hole 38 which extends the length of the ferrule 24. The alignment hole 38 is for receiving an alignment pin 20 (shown in FIGS. 1 and 2) which is preferably correspondingly shaped to the hole 38. Preferably, the ferrule 24 has two such alignment holes, but any suitable number may be employed. These alignment holes 38 ensure proper optical alignment of the connectors 10, 12 when they are mated as well as proper alignment of the connectors 12, 14 to other electrical components such as component 11 depicted in FIG. 1.

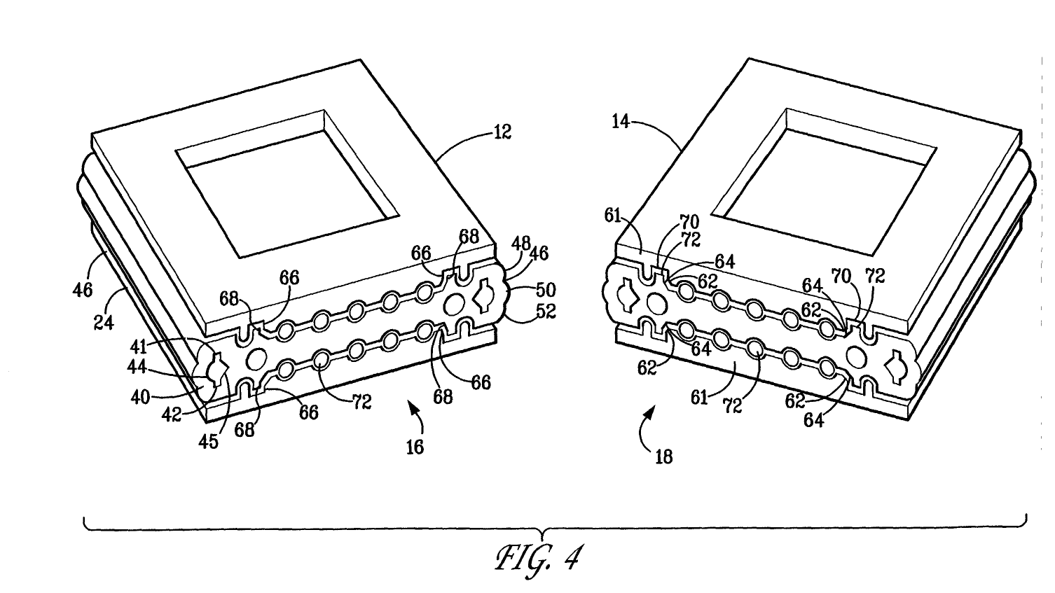

Also disposed within the ferrule 10 may be a pair of alignment grooves 40, as best shown in FIG. 4. Each alignment groove 40 preferably has first slot 41 and a second slot 42. In a preferred embodiment the first and the second slots 41, 42 are disposed substantially vertically. The alignment grooves 40 may further have a portion 44 which is generally circular in shape, and another portion 45 which is substantially v-shaped, as shown in FIG. 5. A correspondingly shaped alignment pin 22 can be inserted into each of the grooves 40 as shown in FIGS. 1 and 2 when mating the connectors 12, 14 and when mating the connectors 12, 14 to an electrical component.

The ferrule 24 may in a preferred embodiment have a pair of sides 46 which includes three rounded portions 48, 50, 52, as shown in FIG. 4. These rounded portions 48, 50, 52 can be used for edge aligning the connectors 12, 14 by aligning the ferrules 24 by their rounded edges 48, 50, 52.

Disposed within the top and bottom of each ferrule 24 may be a key way 54, as best shown in FIG. 3. The key way 54 is generally sized and shaped so as to correspond to the size and shape of a corresponding key 56 of a ferrule cap 26, so that a ferrule cap 26 can be attached to the top and the bottom of the ferrule with the keys 56 and key ways 54. Other shaped keys and key ways can be employed. In addition, other means of attaching the ferrule caps 26 to the ferrule 24 may be employed.

A preferred embodiment of the ferrule cap 26 is depicted in the sub assembly of FIG. 3. The ferrule cap 26 is preferably a single piece of molded thermoplastic material. The ferrule cap 26 can, however, be made from a multitude of pieces or from any suitable material. The ferrule cap 26 preferably has walls 58 which define windows 60 As described in more detail below, an adhesive can be distributed through the windows 60 in order to attach the ferrule caps 26 to the optical fibers 28 and the ferrule 24.

The ferrule cap 26 is preferably sized and shaped so as to mate with the ferrule 24. In the preferred embodiment shown, the ferrule cap 26 has an under side 61. The under side 60 preferably includes a chamfered edges 62, which mates with corresponding chamfered edges 64 of the ferrule 24, as shown in FIG. 4. The under side 61 may further include substantially vertical edges 66 which mates with corresponding vertical edges 68 of the ferrule 24. In addition, the underside 60 may have substantially horizontal edges 70, which mate with the corresponding substantially horizontal edges 72 of the ferrule 24. Keys 56 mate with the key ways 54 of the ferrule 24, so that the ferrule caps 26 can be slid over the ferrule 24 by sliding the keys 56 within the key ways 54. By aligning the keys 56 in the key ways 54, the alignment of the ferrule caps 26 is ensured. Preferably, the keys 56 are press fit into the key ways 54 to create a press fit or an interference fit.

The optical fiber array 28 may include a plurality of optical fibers 72 which are adhered together in a convention manner to form an array as shown in FIG. 6. Each of the optical fibers 72 can fit within a corresponding groove 32 in the ferrule 24.

In order to form two connectors, a subassembly is first formed by starting with the ferrule 24 of FIG. 3. As best understood with reference to FIG. 3, the optical fibers 72 can be inserted into the substantially v-shaped grooves of the ferrule 24 and preferably on both sides of mid-section 30 the ferrule 24. An adhesive, such as an epoxy, can be used to attach the optical fiber arrays 28 to the ferrule 24. Although epoxy is the preferred adhesive, any suitable adhesive may be employed. The ferrule caps 26 can then be attached to the ferrule 24 by sliding the keys 56 of the ferrule caps 26 within the key ways 54 of the ferrule 24. An adhesive, preferably epoxy, can then be inserted through the ferrule cap windows 60 to bind the optical fibers 28 to the ferrule caps 26 and the ferrule cap 26 to the ferrule 24. This creates the subassembly shown in FIG. 3.

This subassembly can then be cut along the dicing line 74 shown in FIG. 3. Although a variety of cutting processes may be used, the subassembly of FIG. 3 is preferably cut with high pressure water jet cutting techniques, such as those that are available from Jet Edge of Minneapolis, Minn. After cutting the subassembly along the dicing line 74, two matching connectors 12, 14 are formed as shown in the perspective view of FIG. 4, each of which has a cut surface 16,18. The cut surfaces 16, 18 each include the cut end of the ferrule 24, the cut ends of the ferrule caps 26 and the cut end of the fiber array 28. Each of the cut surfaces 16 of one connector 12 will precisely match a cut surface 18 of another connector 14. For example, as shown in FIG. 1, the cut ends of the ferrules 24 will precisely match, the cut ends of the ferrules 26 will precisely match and the cut ends of the fiber optical arrays 28 will precisely match.

It will be understood that this process can be done on a mass scale and a plurality of connectors 12, 14 can be formed. The first group of connectors 12 and the second group of connectors 14 can then be grouped separately, and any of the connectors 12 will mate precisely with any of the connectors 14. Because the connectors 12, 14 are precisely cut, they each have cut surfaces 16 that ensures with relatively high precision that any two connectors 12, 14 will match. This ensures a relatively high yield of components, which reduces costs.

Cutting with a high pressure jet further includes (Inventor: please provide additional details on the cutting process—the machinery, the preferred temperatures, preferred pressures, steps involved in the process etc . . . ). We should provide as much information as we can here. Hand drawings explaining the steps may be appropriate. Also, we may want to explain here why this process is beneficial over prior art ways of cutting (assuming that there are such prior art methods). Thus, please provide the benefits of this cutting process.

Any two connectors 12, 14 can be selected and aligned with the alignment pins 20, 22. The alignment pins 20, 22 can be inserted into the alignment holes 38 or slots 40 of the ferrules 24 as shown in FIGS. 2 and 3 to form an aligned connector 10. The connector 10 can then be coupled to a suitable electrical connector 11 that has a corresponding alignment hole for receiving an alignment pin, as shown in FIG. 1.

### SECOND PREFERRED EMBODIMENT

A second preferred embodiment of this invention is depicted in FIGS. 5 and 6. Where the structure is similar to the first embodiment, the references numbers used above for the first embodiment are used for the second embodiment. In this embodiment, a fiber optical ribbon 28 is adhered to a ferrule 24. Preferably, an adhesive and even more preferably an epoxy is used to attach the fiber optical ribbon 28 to the ferrule 24. After attaching the fiber optical ribbon 28, the subassembly of FIG. 6 is formed. This subassembly can then be cut along a dicing line 74 as shown in FIG. 6 to form two matching connectors. The dicing line is preferably at a specified angle. The high pressure jet cutting process described above can be used in forming these matching connectors as well.

This embodiment differs from the first embodiment in that the fiber optical ribbon 28 is disposed between a set of ferrules 24. In contrasts, in the first embodiment, the optical fiber is disposed between a ferrule and a ferrule cap.

### THIRD PREFERRED EMBODIMENT

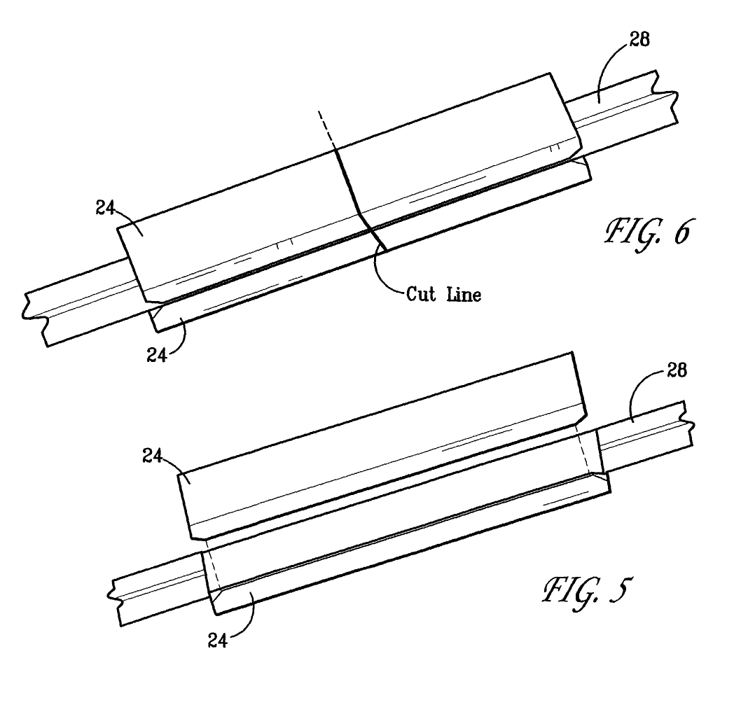

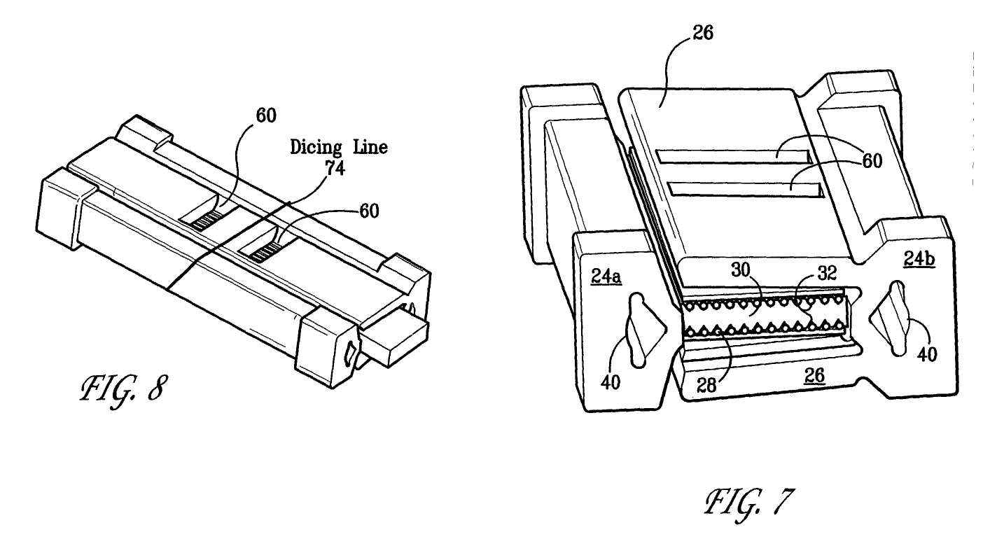

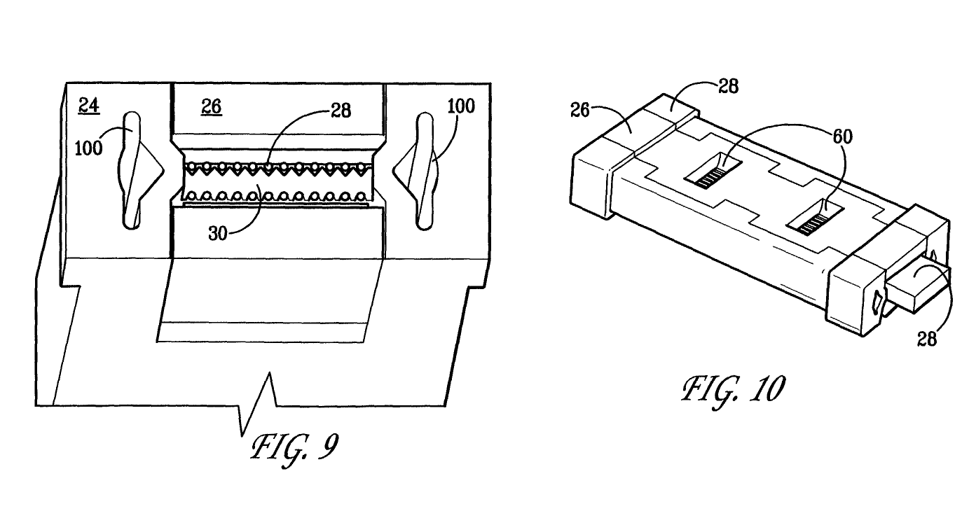

FIGS. 7 and 8 depict a third preferred embodiment of this invention. Although this embodiment is similar to the first preferred embodiment of the method and systems of this invention, there are some differences. The major difference is that this embodiment is a one-piece ferrule. One-piece refers to the unitary or single piece construction of the ferrule. The ferrule can be made by, for example, molding to form a one-piece ferrule. Another difference as shown in FIG. 7, is that there is only one set of alignment holes 40. There could be, however, any number of alignment holes 40 for receiving alignment pins.

The one-piece ferrule has a mid-section 30 that has a first side and a second side that each have a plurality of groves 32 for receiving a plurality of optical fibers. The ferrule includes a first end 24a and a second end 24b which each have an alignment hole 40 extending therethrough. The first end 24a and the second end 24b extend from the mid-section 30 and are integrally formed with the mid-section 30.

Integrally formed with the ferrule are the ferrule covers 26. Preferably, the ferrule coves 26 are formed so that they extend from one of the ferrule ends 24a, 24b. Each cover 26 extends over the mid-section 30 and over the optical fiber array. Windows 60 may be disposed within each cover. Although only the windows 60 in one of the covers are visible in FIG. 7, it will be appreciated that the bottom ferrule cover has windows as well. An adhesive, preferably an epoxy, can be applied through the window to adhere the optical fiber array 28 to the ferrule 24. As shown in FIGS. 7 and 8, the ferrule mid-section 30 can be sandwiched between the ferrule covers 26.

Thus in this embodiment the ferrule is one-piece. The covers 26 are integral with the ferrule mid-section 30, as are the ferrules ends 24a, 24b.

The ferrule assembly can be cut along the dicing line of FIG. 8 with the water cutting process described above to form two matching connectors. As with the embodiments described above this process can be repeated to create a plurality of matching connectors. The connectors formed from this third preferred embodiment are preferably MPO connectors, which are preferably MTP compatible.

### FOURTH PREFERRED EMBODIMENT

This fourth preferred embodiment of FIGS. 10 and 11 are similar to the first preferred embodiment except that this embodiment has only one set of alignment holes and the ferrules is not rounded on the edges for edge alignment. FIG. 10 depicts the ferrule subassembly prior to the subassembly being cut along a dicing line with the high pressure jet process described above. FIG. 11 is a perspective view showing the optical fiber array 28 disposed in the mis-section 30 and the alignment holes. The connectors of this embodiment are based on the MT Ferrule and can be MTP or MPO type.

### FIFTH PREFERRED EMBODIMENT

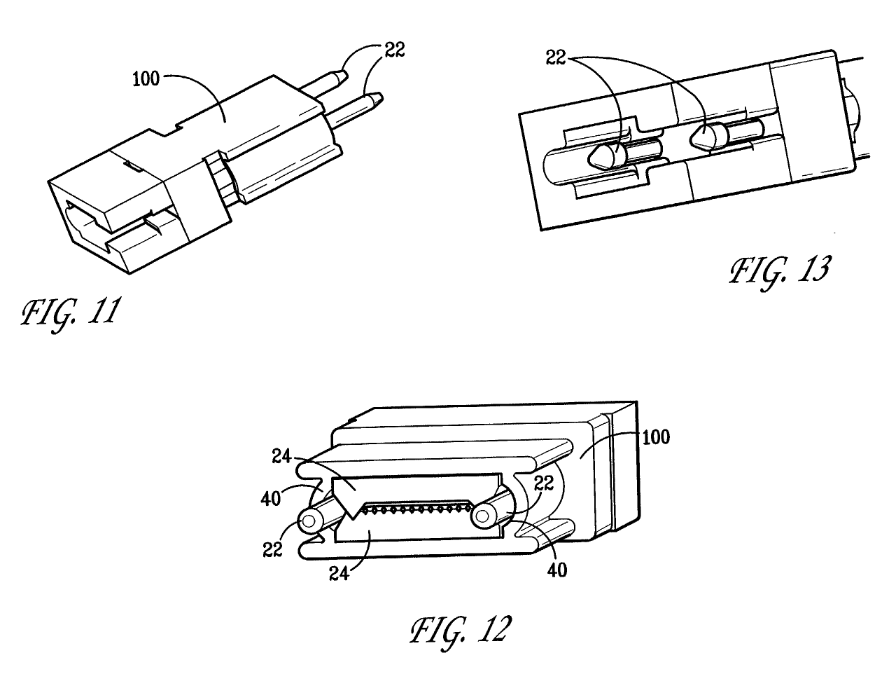

FIGS. 11-13 illustrate a fifth preferred embodiment. In this embodiment, the ferrule 24 is disposed within a ferrule housing 100, as best shown in FIG. 11. This embodiment differs from those described above in that the optical fiber array 28 is sandwiched between the ferrules 24, as opposed to between a ferrule 24 and cover.

Alignment holes 40 may be formed between the housing 100 and the ferrules 24. FIGS. 11-13 depict alignment pins inserted into the alignment holes. FIG. 13 further illustrates an MPO pin clamp attached to the connector. The connector of this embodiment is preferably as MPO connector that is MTP compatible.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An optical fiber connector, comprising:
a ferrule comprising a middle section comprising a first side, a second side, and a plurality of grooves for receiving an optical fiber formed in the first side and the second side; and
a plurality of optical fibers disposed within each of the plurality of grooves.

2. The optical fiber connector of claim 1, wherein the plurality of grooves for receiving the optical fibers are substantially v-shaped.

3. The optical fiber connector of claim 1, further comprising a first ferrule cap disposed over the plurality of optical fibers disposed in the grooves of the first side of the ferrule middle section.

4. The optical fiber connector of claim 3, further comprising a second ferrule cap disposed over the plurality of optical fibers disposed in the grooves of the second side of the ferrule middle section.

5. The optical fiber connector of claim 3, wherein the ferrule comprises a key way and the first ferrule cap comprises a key and the ferrule cap key is slid into the ferrule key way to attach the ferrule and the first ferrule cap.

6. The optical fiber connector of claim 3, wherein the first ferrule cap comprises a window.

7. The optical fiber connector of claim 1, wherein the ferrule comprises an alignment hole.

8. The optical fiber connector of claim 1, wherein the ferrule comprises an alignment slot.

9. The optical fiber connector of claim 8, wherein the alignment slot comprises a v-shaped portion.

10. The optical fiber connector of claim 9, wherein the alignment slot comprises a v-shaped portion and a rounded portion.

11. A method of making a pair of optical fiber connectors, comprising:
attaching a plurality of optical fibers to a ferrule;
attaching a ferrule cap to the plurality of optical fibers and the ferrule; and
cutting the ferrule cap, the plurality of optical fibers and the ferrule cap with a high pressure water source to form two optical fibers connectors.

12. The method of claim 11, wherein attaching the plurality of optical fibers to the ferrule comprises attaching the plurality of fibers to the ferrule with an adhesive.

13. The method of claim 12, wherein the adhesive comprises epoxy.

14. The method of claim 11, wherein attaching the ferrule cap to the plurality of optical fibers and the ferrule comprises applying an adhesive.

15. The method of claim 14, wherein the adhesive comprises epoxy.

16. The method of claim 11, wherein cutting comprises cutting the ferrule cap, the plurality of optical fibers and the ferrule cap along a dicing line.

17. An optical fiber connector, comprising:
a middle section having a first side and a second side, the first side and the second side each having a plurality of grooves for receiving an optical fiber; and
a first alignment hole comprising a first and a second substantially linear shaped slots, a first portion that is substantially arc shaped, and a second portion that is substantially v-shaped.

18. The ferrule assembly of claim 17, further comprising an adhesive that bonds on a first optical fiber array to the first side of the ferrule and a second optical fiber array to a second side of the ferrule.

19. The ferrule assembly of claim 17, wherein the plurality of grooves are substantially v-shaped.

20. A one-piece ferrule for receiving an optical fiber array, comprising:
a mid-section that has a first set of grooves for receiving a plurality of optical fibers; and
a first cover disposed over the mid-section.

21. The ferrule of claim 20, further comprising a first end extending from the mid-section that has an alignment hole extending therethrough.

22. The ferrule of claim 21, further comprising a second end extending from the mid-section that has an alignment hold extending therethrough.

23. The ferrule of claim 22 wherein the first cover extends from the first end.

24. The ferrule of claim 23, wherein the first cover comprises a window.

25. The ferrule of claim 20, wherein the first set of grooves are disposed on a first side of the ferrule mid-section.

26. The ferrule of claim 25, further comprising an adhesive disposed between the mid-section and the first cover that attaches an optical fiber in each of the grooves.

27. The ferrule of claim 27, wherein the adhesive comprises epoxy.

28. The ferrule of claim 25, further comprising a second set of grooves that are disposed on a second side of the ferrule mid-section and wherein the ferrule further comprises a second cover that extends from the first end over the second side of the mid-section.

29. The ferrule of claim 28, further comprising an adhesive disposed between the mid-section and the second cover that attaches a second set of optical fibers to the second set of mid-section grooves.

30. The ferrule of claim 29, wherein the adhesive comprises epoxy.
